(19) United States
(12) Patent Application Publication
(10) Pub. No.: US 2022/0311606 A1
(43) Pub. Date: Sep. 29, 2022

(54) OPTICAL COMMUNICATION APPARATUS, OPTICAL COMMUNICATION SYSTEM AND METHOD

(71) Applicants: BEIJING BOE TECHNOLOGY DEVELOPMENT CO., LTD., Beijing (CN); BOE TECHNOLOGY GROUP CO., LTD., Beijing (CN)

(72) Inventors: Yiming BAI, Beijing (CN); Xiangye WEI, Beijing (CN); Liming XIU, Beijing (CN); Xin LI, Beijing (CN)

(21) Appl. No.: 17/297,540

(22) PCT Filed: Jun. 10, 2020
(86) PCT No.: PCT/CN2020/095261

§ 371 Date: May 27, 2021

(51) Int. Cl. H04L 9/08; H04B 10/116; H04B 10/508; H04L 9/14

(52) U.S. Cl. CPC H04L 9/0869; H04B 10/116; H04B 10/508; H04L 9/14

(57) ABSTRACT

The optical communication apparatus includes a random number generator, a first key manager, a first encryption and decryption device, a driver and a transmitter. The random number generator is configured to generate a random number based on a time frequency. The first key manager is configured to generate a first key based on the random number, store and manage the first key and a second key obtained from an outside. The first encryption and decryption device is configured to encrypt the first key according to the second key to obtain a first encrypted key, and is configured to encrypt initial communication data according to the first key to obtain encrypted data. The driver is configured to obtain the encrypted data and encode the encrypted data into a visible light emission instruction. The first transmitter is configured to receive the visible light emission instruction and emit first visible light.

### CROSS-REFERENCE TO RELATED APPLICATIONS

This application is a national phase entry under 35 USC 371 of International Patent Application No. PCT/CN2020/095261, filed on Jun. 10, 2020, which is incorporated herein by reference in its entirety.

### TECHNICAL FIELD

The present disclosure relates to the field of communication technologies, and in particular, to optical communication apparatuses, an optical communication system and an optical communication method.

### BACKGROUND

With the rapid development of the Internet of Things, a problem of data security has gradually come into a visual field of people. Since data is closely related to personal privacy of a user, better protection of data, such as encrypted transmission of data, can effectively prevent communication theft and bring secure user experience to the user.

### SUMMARY

In one aspect, a first optical communication apparatus is provided. The optical communication apparatus includes a random number generator, a first key manager, a first encryption and decryption device, a driver and a transmitter. The random number generator is configured to generate a random number based on a time frequency. The first key manager is configured to generate a first key based on the random number, store and manage the first key and an obtained second key. The first encryption and decryption device is connected to the first key manager, and is configured to encrypt the first key according to the second key to obtain a first encrypted key, and is configured to encrypt initial communication data according to the first key to obtain first encrypted data. The driver is connected to the first encryption and decryption device, and is configured to obtain the first encrypted data and encode the first encrypted data into a visible light emission instruction. The transmitter is connected to the driver, and is configured to receive the visible light emission instruction and emit first visible light according to the visible light emission instruction.

In some embodiments, the random number generator includes a pulse generation sub-circuit, a frequency locked loop and a random number generation sub-circuit. The pulse generation sub-circuit is configured to generate a plurality of pulses, and a frequency of the pulses changes with changes in an environmental parameter. The frequency locked loop includes a phase frequency detection sub-circuit and a feedback sub-circuit. The phase frequency detection sub-circuit is configured to generate a phase relationship indicating signal and a frequency relationship indicating signal according to a relationship between a phase of an input signal and a phase of a feedback signal. The phase relationship indicating signal indicates whether the phase of the input signal leads the phase of the feedback signal. The frequency relationship indicating signal indicates a relationship between a magnitude of a frequency of the input signal and a magnitude of a frequency of the feedback signal. The feedback sub-circuit is configured to generate the feedback signal according to the frequency relationship indicating signal and the frequency of the pulses. The random number generation sub-circuit is configured to generate the random number according to the phase relationship indicating signal.

In some embodiments, the feedback sub-circuit includes a controller, a digitally controlled oscillator and a first frequency divider. The controller is configured to generate a frequency control word according to the frequency relationship indicating signal. The digitally controlled oscillator is configured to generate an intermediate signal according to the frequency control word and the frequency of the pulses. A frequency of the intermediate signal is

$$K \times \frac{f}{F} ,$$

where K is a number of the pulses generated by the pulse generation sub-circuit, f is the frequency of the pulses, and F is the frequency control word. The first frequency divider is configured to divide the frequency of the intermediate signal to generate the feedback signal.

In some embodiments, the random number generator further includes an input device configured to transmit the input signal. The input device includes a crystal oscillator, a micro-electro-mechanical system or an oscillator.

In some embodiments, the first key manager includes a first key generator and a first memory. The first key generator is configured to obtain the random number and generate the first key. The first memory is configured to store and manage the first key and the second key.

In another aspect, a second optical communication apparatus is provided. The optical communication apparatus includes: a second key manager, a visible light receiver and a second encryption and decryption device. The second key manager is configured to store and manage a third key and a fourth key obtained from an outside. The visible light receiver is configured to receive second visible light and decode the second visible light into second encrypted data. The second encryption and decryption device is connected to the second key manager and the visible light receiver. The second encryption and decryption device is configured to decrypt the fourth key according to the third key to obtain a fifth key, and decrypt the second encrypted data according to the fifth key to obtain initial communication data.

In some embodiments, the second key manager includes a third key generator and a second memory. The third key generator is configured to generate the third key. The second memory is configured to store and manage the third key and the fourth key.

In some examples, the third key is an asymmetric key. The third key includes a first public key and a first private key, and the first public key and the first private key are used in pair. The fourth key is a key obtained by encrypting the fifth key with the first public key. The second encrypted data is data by encrypting the initial communication data with the fifth key. The second encryption and decryption device is configured to decrypt the fourth key according to the first private key.

In some other examples, the third key is a symmetric key. The fourth key is a key obtained by encrypting the fifth key with the third key. The second encrypted data is data obtained by encrypting the initial communication data with the fifth key.

In some embodiments, the visible light receiver includes a photoelectric sensor or an image sensor.

In yet another aspect, an optical communication system is provided. The optical communication system includes an optical signal transmitter and an optical signal receiver. The optical signal transmitter includes the first optical communication apparatus as described above. The optical signal receiver includes the second optical communication apparatus as described above. The first visible light and the second visible light are the same visible light, and the first encrypted data and the second encrypted data are the same encrypted data.

The first key in the optical signal transmitter and the fifth key in the optical signal receiver are a same key. The first encrypted key in the optical signal transmitter and the fourth key in the optical signal receiver are a same key.

The second key in the optical signal transmitter is one of a first public key of the third key that is an asymmetric key and the third key that is a symmetric key in the optical signal receiver.

In some embodiments, the optical signal receiver further includes a third optical communication apparatus, and the third optical communication apparatus includes: another random number generator, another first key manager, another first encryption and decryption device, another driver, and another transmitter. The another random number generator is configured to generate a random number based on a time frequency. The another first key manager is configured to generate a first key based on the random number generated by the another random number generator, store and manage the first key generated by the another first key manager and an obtained second key. The another first encryption and decryption device is connected to the another first key manager, and is configured to encrypt the first key generated by the another first key manager according to the second key stored in the another first key manager to obtain a first encrypted key, and is configured to encrypt initial communication data according to the first key generated by the another first key manager to obtain third encrypted data. The another driver is connected to the another first encryption and decryption device, and is configured to obtain the third encrypted data and encode the third encrypted data into a visible light emission instruction. The another transmitter is connected to the another driver, and is configured to receive the visible light emission instruction encoded by the another driver and emit third visible light according to the visible light emission instruction encoded by the another driver.

In some embodiments, the optical signal transmitter further includes a fourth optical communication apparatus, and the fourth optical communication apparatus includes another second key manager, another visible light receiver and another second encryption and decryption device. The another second key manager is configured to store and manage a third key and a fourth key obtained from an outside. The another visible light receiver is configured to receive fourth visible light and decode the fourth visible light into fourth encrypted data. The another second encryption and decryption device is connected to the another second key manager and the another visible light receiver. The another second encryption and decryption device is configured to decrypt the fourth key stored in the another second key manager according to the third key stored in the another second key manager to obtain a fifth key, and decrypt the fourth encrypted data according to the fifth key obtained by the another second encryption and decryption device to obtain initial communication data.

In yet another aspect, an optical communication method applied to the optical communication system as described above is provided. The optical communication method includes:

storing and managing, by the second key manager, the third key; obtaining and storing, by the first key manager, the third key that is the symmetric key or the first public key of the third key that is the asymmetric key, and managing, by the first key manager, the third key that is the symmetric key or the first public key of the third key that is the asymmetric key as the second key;

generating, by the random number generator, the random number based on the time frequency; obtaining, by the first key manager, the random number, and generating, by the first key manager, the first key according to the random number; and storing and managing, by the first key manager, the first key;

encrypting, by the first encryption and decryption device, the first key according to the second key to obtain the first encrypted key;

storing, by the second key manager, the first encrypted key, and managing, by the second key manager, the first encrypted key as the fourth key; decrypting, by the second encryption and decryption device, the fourth key according to the third key that is the symmetric key or a first private key of the third key that is the asymmetric key to obtain the first key; and storing, by the second key manager, the first key, and managing, by the second key manager, the first key as the fifth key;

encrypting, by the first encryption and decryption device, the initial communication data according to the first key to obtain the encrypted data; receiving, by the driver, the encrypted data, and encoding, by the driver, the encrypted data into the visible light emission instruction; and receiving, by the transmitter, the visible light emission instruction, and emitting, by the transmitter, the visible light according to the visible light emission instruction; and

receiving, by the visible light receiver, the visible light, and decoding, by the visible light receiver, the visible light into the encrypted data; and decrypting, by the second encryption and decryption device, the encrypted data according to the fifth key to obtain the initial communication data.

In some embodiments, the random number generator includes a pulse generation sub-circuit, a frequency locked loop and a random number generation sub-circuit, and the frequency locked loop includes a phase frequency detection sub-circuit and a feedback sub-circuit. Generating, by the random number generator, the random number based on the time frequency includes:

generating, by the pulse generation sub-circuit, a plurality of pulses, a frequency of the pulses changing with changes in an environmental parameter;

generating, by the phase frequency detection sub-circuit, a phase relationship indicating signal and a frequency relationship indicating signal according to a relationship between a phase of an input signal and a phase of a feedback signal, the phase relationship indicating signal indicating whether the phase of the input signal leads the phase of the feedback signal, and the frequency relationship indicating signal indicating a relationship between a magnitude of a frequency of the input signal and a magnitude of a frequency of the feedback signal; and the feedback signal being generated by the feedback sub-circuit according to the frequency relationship indicating signal and the frequency of the pulses; and

generating, by the random number generation sub-circuit, the random number according to the phase relationship indicating signal.

In some embodiments, the feedback sub-circuit includes a controller, a digitally controlled oscillator, and a first frequency divider. The feedback signal is generated according to following steps:

a frequency control word is generated by the controller according to the frequency relationship indicating signal;

an intermediate signal is generated by the digitally controlled oscillator according to the frequency control word and the frequency of the pulses, and a frequency of the intermediate signal is

$$K \times \frac{f}{F} ,$$

wherein K is a number of the pulses generated by the pulse generation sub-circuit, f is the frequency of the pulses, and F is the frequency control word; and

the frequency of the intermediate signal is divided by the first frequency divider to generate the feedback signal.

In some embodiments, the first encrypted key, the third key that is the symmetric key or the first public key of the third key that is the asymmetric key are transmitted by using any one of following communication protocols: wireless fidelity (WIFI), wireless mesh network, Bluetooth, ZigBee, Z-Wave, near field communication (NFC) or ultra-wideband (UWB).

In some embodiments, the visible light emission instruction includes at least one of a brightness instruction, a gray-scale instruction, a frequency instruction, a color instruction or a light-emitting area instruction.

In yet another aspect, a non-transitory computer-readable storage medium is provided. The computer-readable storage medium stores computer program instructions that, when running in an optical communication system, cause the optical communication system to perform one or more steps of the optical communication method as described in any one of the above embodiments.

In yet another aspect, a computer program is provided. When running in an optical communication system, the computer program causes the optical communication system to perform one or more steps of the optical communication method as described in any one of the above embodiments.

### BRIEF DESCRIPTION OF THE DRAWINGS

In order to describe technical solutions in some embodiments of the present disclosure more clearly, the accompanying drawings to be used in the description of some embodiments will be introduced briefly below. Obviously, the accompanying drawings to be described below are merely some embodiments of the present disclosure, and a person of ordinary skill in the art may obtain other drawings according to these drawings.

FIG. 1 is a schematic diagram showing a structure of an optical communication apparatus, in accordance with some embodiments of the present disclosure;

FIG. 2 is a schematic diagram showing a structure of another optical communication apparatus, in accordance with some embodiments of the present disclosure;

FIG. 3 is a schematic diagram showing a structure of yet another optical communication apparatus, in accordance with some embodiments of the present disclosure;

FIG. 4 is a schematic diagram showing a structure of a random number generator, in accordance with some embodiments of the present disclosure;

FIG. 5 is a schematic diagram showing a structure of a pulse generation sub-circuit, in accordance with some embodiments of the present disclosure;

FIG. 6 is a schematic diagram showing a structure of a phase frequency detection sub-circuit, in accordance with some embodiments of the present disclosure;

FIG. 7 is a schematic diagram showing waveforms of an input signal and a feedback signal that are input to the phase frequency detection sub-circuit shown in FIG. 6;

FIG. 8 is a schematic diagram showing a structure of a digitally controlled oscillator, in accordance with some embodiments of the present disclosure;

FIG. 9 is a schematic diagram showing a principle of generating an intermediate signal based on a time average frequency, in accordance with some embodiments of the present disclosure;

FIG. 10 is a schematic diagram showing a structure of a transmitter, in accordance with some embodiments of the present disclosure;

FIG. 11 is a schematic diagram showing a structure of yet another optical communication apparatus, in accordance with some embodiments of the present disclosure;

FIG. 12 is a schematic diagram showing a structure of yet another optical communication apparatus, in accordance with some embodiments of the present disclosure;

FIG. 13 is a schematic diagram showing a structure of yet another optical communication apparatus, in accordance with some embodiments of the present disclosure;

FIG. 14 is a schematic diagram showing a structure of an optical communication system, in accordance with some embodiments of the present disclosure;

FIG. 15 is a schematic diagram showing a structure of another optical communication system, in accordance with some embodiments of the present disclosure;

FIG. 16 is a diagram showing a data transmission path in an optical communication method, in accordance with some embodiments of the present disclosure;

FIG. 17 is a schematic hierarchical diagram of an optical communication principle, in accordance with some embodiments of the present disclosure; and

FIG. 18 is a schematic diagram showing a structure of yet another optical communication system, in accordance with some embodiments of the present disclosure.

### DETAILED DESCRIPTION

Technical solutions in some embodiments of the present disclosure will be described clearly and completely below with reference to the accompanying drawings in some embodiments of the present disclosure. Obviously, the described embodiments are merely some but not all embodiments of the present disclosure. All other embodiments obtained by a person of ordinary skill in the art based on the embodiments of the present disclosure shall be included in the protection scope of the present disclosure.

Unless the context requires otherwise, the term “comprise” and other forms thereof such as the third-person singular form “comprises” and the present participle form “comprising” throughout the description and the claims are construed as open and inclusive meaning, i.e., “including, but not limited to”. In the description, the terms such as “one embodiment”, “some embodiments”, “exemplary embodiments”, “example”, “specific example”, or “some examples” are intended to indicate that specific features, structures, materials or characteristics related to the embodiment(s) or example(s) are included in at least one embodiment or example of the present disclosure. Schematic representations of the above terms do not necessarily refer to the same embodiment(s) or example(s). In addition, the specific features, structures, materials, or characteristics may be included in any one or more embodiments or examples in any suitable manner.

Hereinafter, the terms such as “first” and “second” are used for descriptive purposes only, and are not to be construed as indicating or implying the relative importance or implicitly indicating the number of indicated technical features. Thus, features defined with “first” or “second” may explicitly or implicitly include one or more of the features. In the description of the embodiments of the present disclosure, the term “a/the plurality of” means two or more unless otherwise specified.

In the description of some embodiments, the terms such as “coupled” and “connected” and their derivatives may be used. For example, the term “connected” may be used in the description of some embodiments to indicate that two or more components are in direct physical or electric contact with each other. For another example, the term “coupled” may be used in the description of some embodiments to indicate that two or more components are in direct physical or electric contact. However, the term “coupled” or “communicatively coupled” may also mean that two or more components are not in direct contact with each other, but still cooperate or interact with each other. The embodiments disclosed herein are not necessarily limited to the contents herein.

The phrase “at least one of A, B and C” has a same meaning as the phrase “at least one of A, B or C”, and they both include the following combinations of A, B and C: only A, only B, only C, a combination of A and B, a combination of A and C, a combination of B and C, and a combination of A, B and C.

The phrase “A and/or B” includes the following three combinations: only A, only B, and a combination of A and B.

As used herein, the term “if” is optionally construed as “when” or “in a case where” or “in response to determining” or “in response to detecting”, depending on the context. Similarly, the phrase “if it is determined” or “if [a stated condition or event] is detected” is optionally construed as “in a case where it is determined” or “in response to determining” or “in a case where [the stated condition or event] is detected” or “in response to detecting [the stated condition or event]”, depending on the context.

The use of the phrase “applicable to” or “configured to” herein means an open and inclusive expression, which does not exclude devices that are applicable to or configured to perform additional tasks or steps.

In addition, the use of the phrase “based on” is meant to be open and inclusive, since a process, step, calculation or other action that is “based on” one or more of the stated conditions or values may, in practice, be based on additional conditions or values other than those stated.

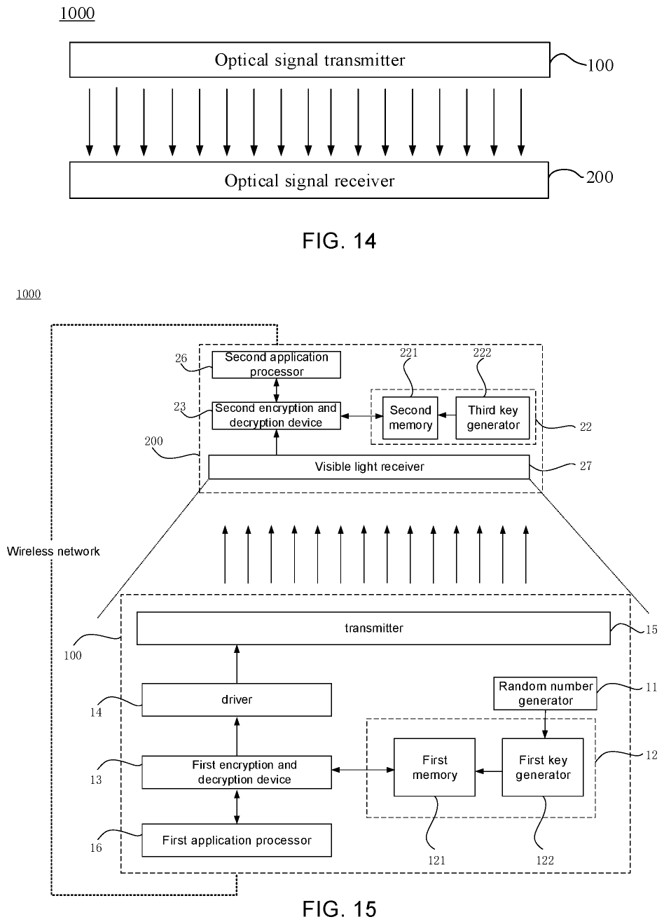

With the rapid development of the Internet of Things, it has become very important to protect data securely transmitted over a network. Some embodiments of the present disclosure provide an optical communication system. As shown in FIG. 14, the optical communication system 1000 includes an optical signal transmitter 100 and an optical signal receiver 200. The optical signal transmitter 100 is capable of encrypting initial communication data to be transmitted and emitting the initial communication data in a manner of visible light. The optical signal receiver 200 is capable of receiving the visible light, and decoding and decrypting the visible light into the initial communication data. The optical communication system 1000 may control its communication range within a propagation path of the visible light to form a stable encrypted data transmission system.

The optical signal transmitter 100 and the optical signal receiver 200 may both be regarded as optical communication apparatuses with different structures and functions. Detailed exemplary descriptions will be made below with regard to a first optical communication apparatus used as the optical signal transmitter 100 and a second optical communication apparatus used as the optical signal receiver 200.

It can be understood that, for convenience of description, in some of the following embodiments, the first optical communication apparatus is directly referred to as the optical signal transmitter 100, and the second optical communication apparatus is directly referred to as the optical signal receiver 200. In addition, corresponding components with same functions and/or structures in the first optical communication apparatus and the second optical communication apparatus are distinguished by adding respective ordinal numbers before their names, which does not mean that their structures or functions are different, and can be specifically understood in combination with practical applications.

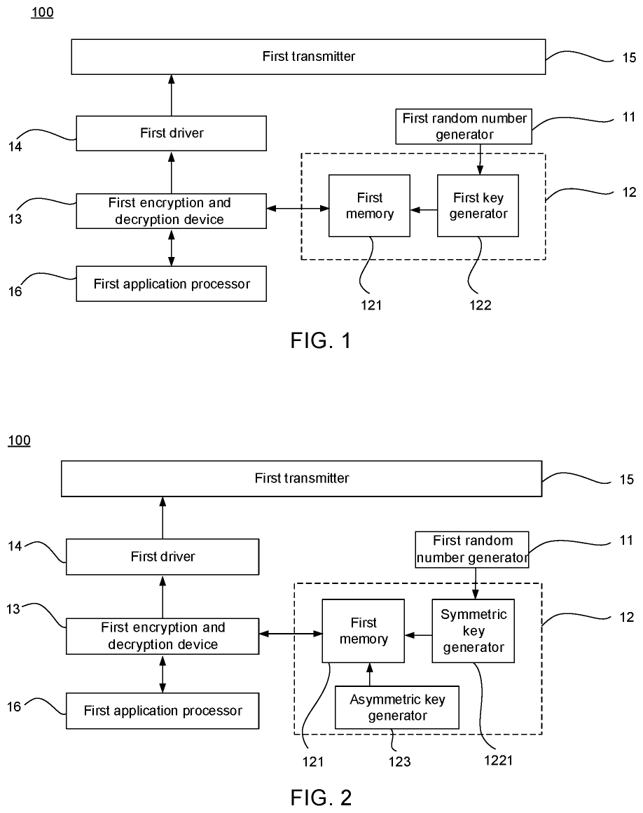

In some embodiments, referring to FIG. 1, the optical signal transmitter 100 includes a first random number generator 11, a first key manager 12, a first encryption and decryption device 13, a first driver 14 and a first transmitter 15.

The first random number generator 11 is configured to generate a random number based on a time frequency. The first key manager 12 is configured to generate a first key based on the random number, store and manage the first key and an obtained second key. The first encryption and decryption device 13 is connected to the first key manager 12, and is configured to encrypt the first key according to the second key to obtain a first encrypted key, and is configured to encrypt the initial communication data according to the first key to obtain first encrypted data.

A key to encryption lies in unpredictability and high complexity of a key. Optionally, the first random number generator 11 is a chip capable of converting thermal noise into a 0/1 digital bit stream. Thermal noise in an environment is a standard Gaussian distribution with good randomness. Two frequency sources with thermal noise are provided in the chip, and a time-frequency relationship between the thermal noise of the two frequency sources may be used to improve the randomness of the thermal noise in the environment, so that the digital bit stream output by the first random number generator 11 have higher unpredictability. Therefore, it is ensured that the generated random number has better randomness.

The first key manager 12 is capable of storing and managing various types of keys required by the optical signal transmitter 100, which include, for example, the first key generated therein based on the random number, and the second key obtained from an outside.

For example, the first key manager 12 includes a first memory 121 and a first key generator 122. The first key generator 122 is configured to obtain the random number and generate the first key. The first memory 121 is configured to store and manage the first key and the second key.

Here, the first key is obtained by performing digit interception or operations on the random number. Of course, the first key may also be directly constituted by the random number. The embodiments of the present disclosure do not limit thereto.

In some examples, referring to FIG. 2, the first key generator 122 is a symmetric key generator 1221, and the first key generated by the symmetric key generator 1221 is a symmetric key. The symmetric key is also referred to as a dedicated key. That is, transmitter for sending data and receiver for receiving data must use the same key to encrypt and decrypt a plaintext, respectively. The first key is the symmetric key, which facilitates to encrypt the initial communication data by using the first key and ensures that the optical signal receiver 200 performs decryption by using the first key. On this basis, by using the second key to encrypt the first key, it may be ensured that the first key for encrypting the initial communication data is transmitted to the optical signal receiver 200 in an encrypted form.

Here, the second key stored in the first key manager 12 is obtained from the outside, and it may be a symmetric key or a public key in an asymmetric key that is transmitted by the optical signal receiver 200.

The asymmetric key includes the public key and a private key. The public key and the private key are used in pair. If data is encrypted by using a public key, it can only be decrypted by using a corresponding private key. If data is encrypted by using a private key, it can only be decrypted by using a corresponding public key. Two different keys are used for the data encryption and decryption.

Optionally, with continued reference to FIG. 2, the first key manager 12 further includes an asymmetric key generator 123 configured to generate an asymmetric key. The first memory 121 is further configured to store and manage the asymmetric key. By providing the asymmetric key generator 123 in the first key manager 12 of the optical signal transmitter 100, it is able to facilitate communications between the optical signal transmitter 100 and both the optical signal receiver 200 and an external communication device by using other encryption methods.

In some examples, the first encryption and decryption device 13 is an encryption chip. The first encryption and decryption device 13 is capable of receiving an application request, and calling keys from the first key manager 12 to perform an encryption or decryption operation.

The first driver 14 is connected to the first encryption and decryption device 13, and is configured to obtain the first encrypted data and encode the first encrypted data into a visible light emission instruction. The first transmitter 15 is connected to the first driver 14, and is configured to receive the visible light emission instruction and emit first visible light according to the visible light emission instruction.

After the first encryption and decryption device 13 encrypts the first key according to the second key and obtains the first encrypted key, the first encrypted key can be transmitted to the optical signal receiver 200 for use of subsequent decryption. After the first encryption and decryption device 13 encrypts the initial communication data according to the first key and obtains the first encrypted data, the first driver 14 is capable of encoding the first encrypted data into the visible light emission instruction to drive the first transmitter 15 to emit the first visible light according to the visible light emission instruction.

The first transmitter 15 includes a light-emitting device capable of emitting visible light, such as a light-emitting diode (abbreviated as LED) or an organic light-emitting diode (abbreviated as OLED).

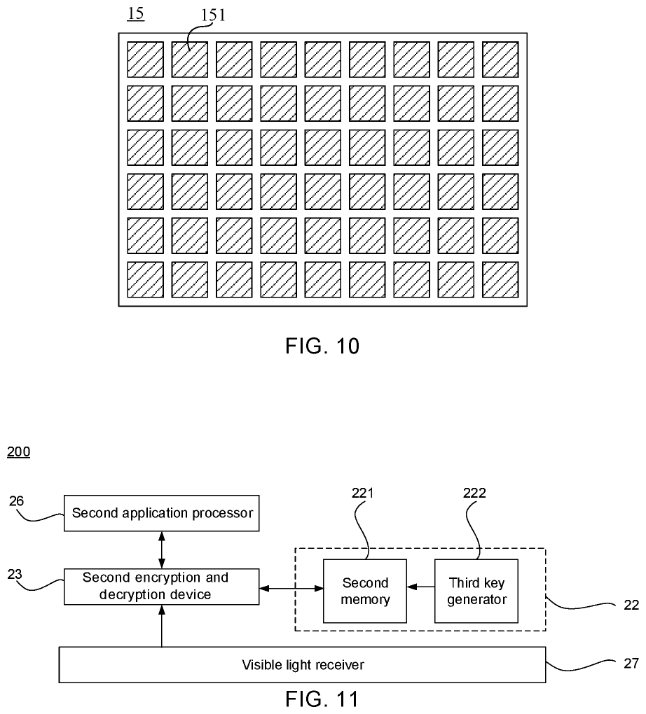

For example, as shown in FIG. 10, the first transmitter 15 is an OLED display screen. Correspondingly, the first driver 14 is a display driver chip or a circuit board. The first driver 14 can be integrated in the OLED display screen and connected to each OLED in the OLED display screen. Correspondingly, the visible light emission instruction includes at least one of a brightness instruction, a gray-scale instruction, a frequency instruction, a color instruction, or a light-emitting area instruction.

In the embodiments of the present disclosure, after receiving the application request, the first encryption and decryption device 13 can call the first key and the second key from the first key manager 11. Then, the first encryption and decryption device 13 is capable of encrypting the first key by using the second key to transmit the first encrypted key to the optical signal receiver 200 through a removable storage device or in a network transmission manner. Moreover, the first encryption and decryption device 13 is capable of encrypting the initial communication data by using the first key, so that the initial communication data may be disguised as the first encrypted data. After receiving the first encrypted data, the first driver 14 may encode the first encrypted data into the visible light emission instruction. The first transmitter 15 emits the first visible light according to the visible light emission instruction, so that data that needs to be communicated can be converted into corresponding visible light to achieve conversion of a form of the data (converting an electrical signal into an optical signal), thereby completing optical communication in a certain direction and achieving data transfer. Therefore, in the embodiments of the present disclosure, the first encrypted key and the first encrypted data are encrypted by using different keys, and are transmitted in different transmission manners, which may achieve multiple encryption guarantees of the data, effectively improve reliability and confidentiality of the data in a whole transmission process, and thereby guarantee communication security of the data.

It will be added that, in the optical signal transmitter 100 shown in FIGS. 1 and 2, the optical signal transmitter 100 further includes a first application processor 16. The first application processor 16 is connected to an application interface, and can receive an application request and perform information interaction with the external communication device. Here, the application interface includes a hardware interface, e.g., a USB interface, and/or, the application interface includes a software interface, e.g., a user interface in an operating system. The first application processor 16 is also connected to the first encryption and decryption device 13, and is capable of achieving bidirectional information interaction with the first encryption and decryption device 13.

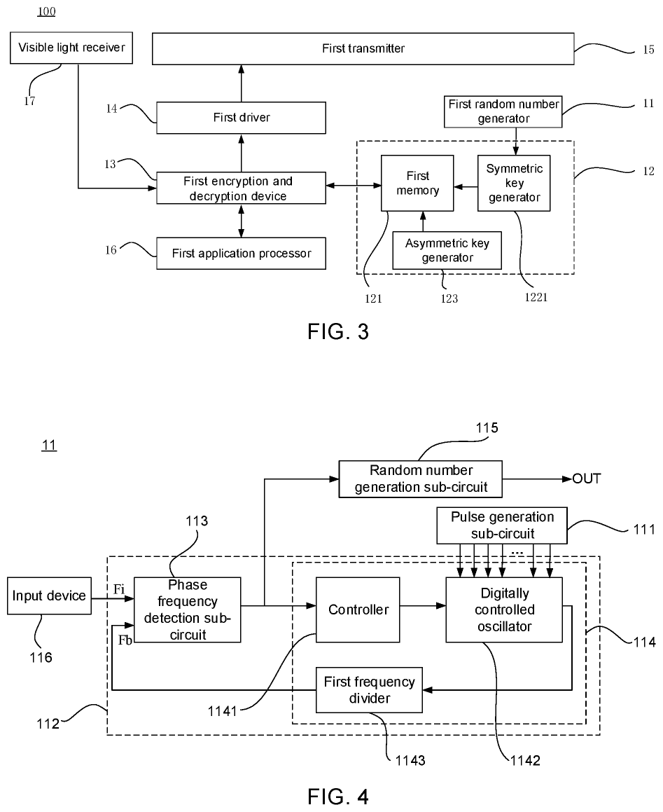

In some other embodiments, as shown in FIG. 3, the optical signal transmitter 100 further includes a first visible light receiver 17. The first visible light receiver 17 is connected to the first encryption and decryption device 13, and is capable of decrypting data by using the first encryption and decryption device 13 and outputting the data after receiving and decoding visible light. In this way, the optical signal transmitter 100 have two functions of transmitting and receiving optical signals.

In some embodiments described above, a structure of the first random number generator 11 may be selectively set according to actual needs. For example, referring to FIG. 4, the first random number generator 11 includes a pulse generation sub-circuit 111, a frequency locked loop (FLL) 112 and a random number generation sub-circuit 115.

The pulse generation sub-circuit 111 is configured to generate a plurality of pulses, and a frequency of the pulses can change with changes in an environmental parameter. For example, the pulse generation sub-circuit 111 is an oscillator, and its oscillation frequency drifts with the change in the environmental parameter (e.g., a temperature).

The FLL 112 is a time average frequency FLL (TAF-FLL), and is configured to lock a frequency of an input signal and a frequency of a feedback signal. The FLL 112 includes a phase frequency detection sub-circuit 113 and a feedback sub-circuit 114. The phase frequency detection sub-circuit 113 is configured to generate a phase relationship indicating signal and a frequency relationship indicating signal according to a relationship between a phase of the input signal Fi (the frequency of which is fi) and a phase of the feedback signal Fb (the frequency of which is fb). The phase relationship indicating signal indicates whether the phase of the input signal Fi leads the phase of the feedback signal Fb. The frequency relationship indicating signal indicates a relationship between a magnitude of the frequency of the input signal Fi and a magnitude of the frequency of the feedback signal Fb.

The random number generation sub-circuit 115 is configured to generate the random number according to the phase relationship indicating signal.

The input signal Fi is a signal emitted by a frequency source with thermal noise. In some examples, the first random number generator 11 further includes an input device 116 configured to transmit the input signal. The input device 116 includes a crystal oscillator, a micro-electro-mechanical system (abbreviated as MEMS) or an oscillator (e.g., a ring oscillator (RO)).

The feedback signal Fb is a signal generated by the feedback sub-circuit 114 according to the frequency relationship indicating signal and the frequency of the pulses.

For example, with continued reference to FIG. 4, the feedback sub-circuit 114 includes a controller 1141, a digitally controlled oscillator 1142 and a first frequency divider 1143.

The controller 1141 is configured to generate a frequency control word according to the frequency relationship indicating signal. For example, the controller 1141 reads an initial frequency control word F from a storage device. In a case where the frequency relationship indicating signal indicates that the frequency fi of the input signal Fi is greater than the frequency fb of the feedback signal Fb, the controller 1141 reduces a current frequency control word by one. In a case where the frequency relationship indicating signal indicates that the frequency fi of the input signal Fi is less than the frequency fb of the feedback signal Fb, the controller 1141 increases the current frequency control word by one.

The digitally controlled oscillator 1142 is configured to generate an intermediate signal according to the frequency control word and the frequency of the pulses.

Here, a frequency of the intermediate signal is

$$K \times \frac{f}{F} ,$$

where K is the number of the pulses generated by the pulse generation sub-circuit 111, f is the frequency of the pulses, and F is the frequency control word.

The first frequency divider 1143 is configured to divide the frequency of the intermediate signal to generate the feedback signal.

In the embodiments of the present disclosure, the input signal Fi transmitted to the FLL 112 is easy to jitter under interference of the thermal noise. Moreover, the frequency of the pulses generated by the pulse generation sub-circuit 111 also drifts with the changes in the environmental parameter. However, regardless of how the input signal Fi jitters and how the frequency of the pulses drifts, the feedback sub-circuit 114 makes the frequency of the feedback signal Fb the same or substantially the same as the frequency fi of the input signal Fi according to the relationship between the magnitude of the frequency of the input signal Fi and the magnitude of the frequency of the feedback signal Fb. Since the phases of the input signal Fi and the feedback signal Fb that are received by the phase frequency detection sub-circuit 113 have high uncertainty due to the jitter of the input signal Fi and the drift of the frequency of the pulses, the phase relationship indicating signal generated according to the phase relationship has high uncertainty. In this way, it is possible to improve the randomness of the random number generated based on the phase relationship indicating signal, thereby generating a true random number (the true random number referring to a random number that can be well distinguished from a pseudo random number, and having high uncertainty).

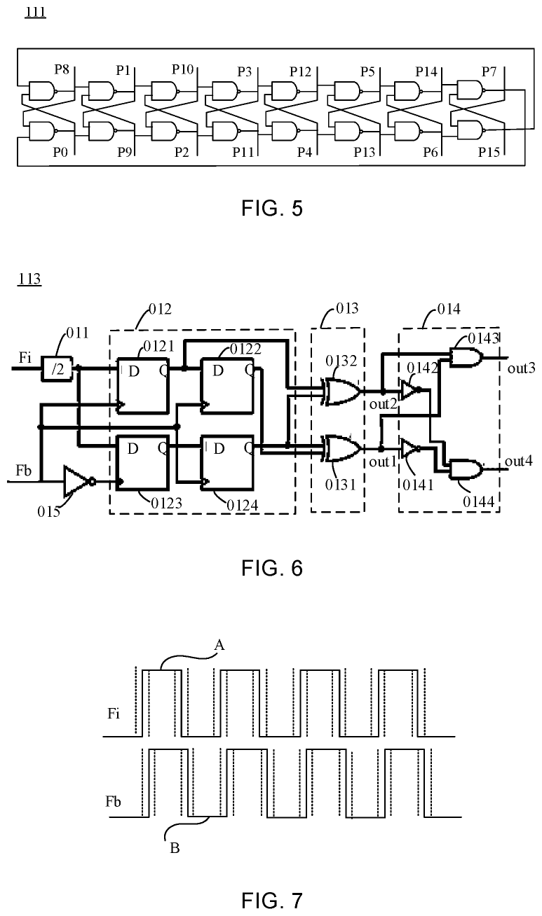

In some examples, the pulse generation sub-circuit 111 includes a ring oscillator, for example, an oscillator based on cross-cascaded NAND gates. FIG. 5 exemplarily shows a circuit structure of the ring oscillator. As shown in FIG. 5, the ring oscillator includes eight stages of NAND gate units (P0 to P15) that are cross-cascaded, and each stage includes a pair of NAND gates. The ring oscillator is capable of generating a plurality of pulses with evenly spaced phases, and the plurality of pulses have great instability. Moreover, an initial condition of oscillation of the ring oscillator is random, and its oscillation frequency is very sensitive to the environment. When the temperature in the environment changes slightly, the oscillation frequency of the ring oscillator drifts.

In some examples, the phase frequency detection sub-circuit 113 is a phase frequency detector (abbreviated as PFD). FIG. 6 exemplarily shows a circuit structure of the PFD. As shown in FIG. 6, the phase frequency detection sub-circuit 113 includes: a first input terminal, a second input terminal, a first output terminal out1, a second output terminal out2, a third output terminal out3, a fourth output terminal out4, and a second frequency divider 011, a register 012, a first logic unit 013 and a second logic unit 014. The first input terminal is configured to receive the input signal Fi with the frequency of fi. The second input terminal is configured to receive the feedback signal Fb with the frequency of fb. The second frequency divider 011 is configured to divide the frequency of the input signal Fi. For example, the second frequency divider 011 is a divide-by-two frequency divider.

The register 012 is configured to obtain a plurality of signal values of an output signal of the second frequency divider 011 at a plurality of edges of the feedback signal Fb. For example, signal values of the second frequency divider 011 at two adjacent rising edges and a falling edge between the two adjacent rising edges of the feedback signal Fb are obtained.

Optionally, the register 012 includes a first D flip-flop 0121, a second D flip-flop 0122, a third D flip-flop 0123 and a fourth D flip-flop 0124. An input terminal of the first D flip-flop 0121 and an input terminal of the third D flip-flop 0123 are both connected to an output terminal of the second frequency divider 011. An input terminal of the second D flip-flop 0122 is connected to an output terminal of the first D flip-flop 0121. An input terminal of the fourth D flip-flop 0124 is connected to an output terminal of the third D flip-flop 0123. A clock terminal of the first D flip-flop 0121, a clock terminal of the second D flip-flop 0122 and a clock terminal of the fourth D flip-flop 0124 are all connected to the second input terminal, and a clock terminal of the third D flip-flop 0123 is connected to the second input terminal through a first NOT gate 015.

The first logic unit 013 is connected to the first output terminal out1 and the second output terminal out2, and the first logic unit 013 is configured to perform logical operations on the plurality of signal values output by the register 012. In a case where the phase of the input signal Fi leads the phase of the feedback signal Fb, the first logic unit 013 outputs a first digital signal to the first output terminal out1 and outputs a second digital signal to the second output terminal out2. In a case where the phase of the input signal Fi lags behind the phase of the feedback signal Fb, the first logic unit 013 outputs a first digital signal to the second output terminal out2 and outputs a second digital signal to the first output terminal out1. The phase relationship indicating signal is obtained by processing an output signal of the first output terminal out1 and an output signal of the second output terminal out2 according to a first logic rule.

For example, the first logic rule is that in a case where the first output terminal out1 outputs the first digital signal and the second output terminal out2 outputs the second digital signal, the phase relationship indicating signal is set to the first digital signal; and in a case where the first output terminal out1 outputs the second digital signal and the second output terminal out2 outputs the first digital signal, the phase relationship indicating signal is set to the second digital signal. That is, in a case where the phase relationship indicating signal is the first digital signal, it indicates that the phase of the input signal leads the phase of the feedback signal; and in a case where the phase relationship indicating signal is the second digital signal, it indicates the phase of the input signal lags behind the phase of the feedback signal.

For example, a value of the first digital signal is 1, and a value of the second digital signal is 0. In a case where a value of the output signal of the first output terminal out1 is 1 and a value of the output signal of the second output terminal out2 is 0, a value of the phase relationship indicating signal is 1. In a case where a value of the output signal of the first output terminal out1 is 0 and a value of the output signal of the second output terminal out2 is 1, a value of the phase relationship indicating signal is 0. In a case where values of the output signal of the first output terminal out1 and the output signal of the second output terminal out2 are both 1 or 0, they are discarded. Therefore, in a case where the value of the phase relationship indicating signal is 1, it indicates that the phase of the input signal leads the phase of the feedback signal; and in a case where the value of the phase relationship indicating signal is 0, it indicates that the phase of the input signal lags behind the phase of the feedback signal.

The second logic unit 014 is connected to the third output terminal out3 and the fourth output terminal out4. The second logic unit 014 is configured to perform logical operations on the output signals of the first output terminal out1 and the second output terminal out2. In a case where the frequency of the input signal Fi is greater than the frequency of the feedback signal Fb, the second logic unit 014 outputs a first digital signal to the third output terminal out3 and outputs a second digital signal to the fourth output terminal out2. In a case where the frequency fi of the input signal Fi is less than the frequency fb of the feedback signal Fb, the second logic unit 014 outputs a second digital signal to the third output terminal out3 and outputs a first digital signal to the fourth output terminal out4. The frequency relationship indicating signal is obtained by processing an output signal of the third output terminal out3 and an output signal of the fourth output terminal out4 according to a second logic rule.

For example, the second logic rule is that in a case where the third output terminal out3 outputs the first digital signal and the fourth output terminal out4 outputs the second digital signal, the frequency relationship indicating signal is set to the first digital signal; and in a case where the third output terminal out3 outputs the second digital signal and the fourth output terminal out4 outputs the first digital signal, the frequency relationship indicating signal is set to the second digital signal. That is, in a case where the frequency relationship indicating signal is the first digital signal, it indicates that the frequency of the input signal is greater than the frequency of the feedback signal; and in a case where the frequency relationship indicating signal is the second digital signal, it indicates that the frequency of the input signal is less than the frequency of the feedback signal.

For example, a value of the first digital signal is 1, and a value of the second digital signal is 0. In a case where a value of the output signal of the third output terminal out3 is 1 and a value of the output signal of the fourth output terminal out4 is 0, a value of the frequency relationship indicating signal is 1. In a case where a value of the output signal of the third output terminal out3 is 0 and a value of the output signal of the fourth output terminal out4 is 1, a value of the frequency relationship indicating signal is 0. In a case where values of the output signal of the third output terminal out3 and the output signal of the fourth output terminal out4 are both 0 or 1, they are discarded. Therefore, in a case where the value of the frequency relationship indicating signal is 1, it indicates that the frequency fi of the input signal Fi is greater than the frequency fb of the feedback signal Fb; and in a case where the value of the frequency relationship indicating signal is 0, it indicates that the frequency fi of the input signal Fi is less than the frequency fb of the feedback signal Fb.

In some examples, with continued reference to FIG. 6, the first logic unit 013 includes a first exclusive-OR gate 0131 and a second exclusive-OR gate 0132. An input terminal of the first exclusive-OR gate 0131 is connected to an output terminal of the second D flip-flop 0122, and the other input terminal of the first exclusive-OR gate 0131 is connected to an output terminal of the fourth D flip-flop 0124. An input terminal of the second exclusive-OR gate 0132 is connected to the output terminal of the first D flip-flop 0121, and the other input terminal of the second exclusive-OR gate 0132 is connected to the output terminal of the fourth D flip-flop 0124. An output terminal of the first exclusive-OR gate 0131 is connected to the first output terminal out1. An output terminal of the second exclusive-OR gate 0132 is connected to the second output terminal out2.

The second logic unit 014 includes a second NOT gate 0141, a third NOT gate 0142, a first AND gate 0143 and a second AND gate 0144. An input terminal of the first AND gate 0143 is connected to the first output terminal out1, and the other input terminal of the first AND gate 0143 is connected to the second output terminal out2. An input terminal of the second AND gate 0144 is connected to the first output terminal out1 through the second NOT gate 0141, and the other input terminal of the second AND gate 0144 is connected to the second output terminal out2 through the third NOT gate 0142.

FIG. 7 is a schematic diagram of waveforms of the input signal Fi and the feedback signal Fb input to the phase frequency detection sub-circuit 113 in some embodiments described above. As shown in FIG. 7, the solid line A represents an ideal waveform of the input signal Fi, and the solid line B represents an ideal waveform of the feedback signal Fb. Both the input signal Fi and the feedback signal Fb will jitter due to respective thermal noise. The dashed lines represent boundaries of pulse edges of the ideal waveform of the input signal Fi or the feedback signal Fb when it is disturbed by the thermal noise, and probabilities that the pulse edge appear at any positions between two dash lines adjacent to the pulse edge are the same. When the phase frequency detection sub-circuit 113 determines the relationship between the phase of the input signal Fi and the phase of the feedback signal Fb, multiple random results will occur. For example, the case may occur where the phase of the input signal Fi leads the phase of the feedback signal Fb, or the case may occur where the phase of the input signal Fi lags behind the phase of the feedback signal Fb, or a case may occur where the phase of the input signal Fi is the same as the phase of the feedback signal Fb.

In the phase frequency detection sub-circuit 113 shown in FIG. 6, the feedback signal Fb (or its inverted signal) is used as a clock signal of the first D flip-flop 0121 to the fourth D flip-flop 0124. The input signal Fi is used as an input signal of the first D flip-flop 0121 and the third D flip-flop 0123. When the phases of the input signal and the clock signal of each D flip-flop are extremely close, the D flip-flop is in a metastable state, and there is a possibility of randomly outputting 0 or 1. As a result, the uncertainty of the phase relationship indicating signal generated by the phase frequency detection sub-circuit 113 may be increased, and thereby a degree of the randomness of the random number generated according to the phase relationship indicating signal may be improved.

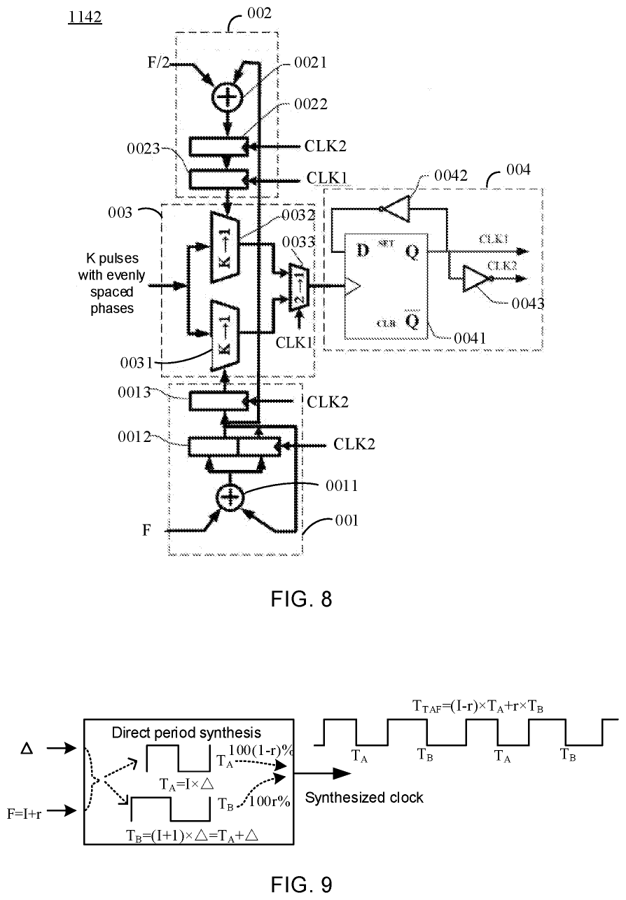

In some examples, the digitally controlled oscillator 1142 in the feedback sub-circuit 114 is a time average frequency-direct period synthesizer based on a time average frequency-direct period synthesis (TAF-DPS) circuit architecture. FIG. 8 exemplarily shows a circuit diagram of the time average frequency-direct period synthesizer.

As shown in FIG. 8, the time average frequency-direct period synthesizer includes a first input sub-circuit, a second input sub-circuit 003 and an output sub-circuit 004. The first input sub-circuit includes a first logic control sub-circuit 001 and a second logic control sub-circuit 002. The first logic control sub-circuit 001 includes a first adder 0011, a first register 0012 and a second register 0013. The second logic control sub-circuit 002 includes a second adder 0021, a third register 0022 and a fourth register 0023.

The second input sub-circuit 003 includes a first K-to-1 multiplexer 0031, a second K-to-1 multiplexer 0032 and a 2-to-1 multiplexer 0033. The first K-to-1 multiplexer 0031 and the second K-to-1 multiplexer 0032 each include a plurality of input terminals, a control input terminal and an output terminal. The plurality of input terminals of the first K-to-1 multiplexer 0031 and the plurality of input terminals of the second K-to-1 multiplexer 0032 are each configured to receive K (K being an integer greater than 1) pulses with evenly spaced phases output by the pulse generation sub-circuit 111. The 2-to-1 multiplexer 0033 includes a control input terminal, an output terminal, a first input terminal for receiving an output signal of the first K-to-1 multiplexer 0031, and a second input terminal for receiving an output signal of the second K-to-1 multiplexer 0032. Here, a time span (e.g., a phase difference) between any two adjacent pulses of the K pulses with the evenly spaced phases may be a reference time unit Δ.

With continued reference to FIG. 8, the output sub-circuit 004 includes a trigger circuit. The trigger circuit is used to generate pulse trains. The trigger circuit includes a D flip-flop 0041, a first inverter 0042 and a second inverter 0043. The D flip-flop 0041 includes a data input terminal, a clock input terminal for receiving an output signal from the output terminal of the 2-to-1 multiplexer 0033, and an output terminal for outputting a first clock signal CLK1. The first inverter 0042 includes an input terminal for receiving the first clock signal CLK1, and an output terminal for outputting a signal to the data input terminal of the D flip-flop 0041. The second inverter 0043 includes an input terminal for receiving the first clock signal CLK1, and an output terminal for outputting a second clock signal CLK2.

The first clock signal CLK1 is output to the control input terminal of the 2-to-1 multiplexer 0033, and the output terminal of the first inverter 0042 is connected to the data input terminal of the D flip-flop 0041.

In some examples, the first adder 0011 may add the frequency control word F and the most significant bits (e.g., 5 bits) stored in the first register 0012, and then save an added result into the first register 0012 in time of a rising edge of the second clock signal CLK2. Or, the first adder 0011 may add the frequency control word F and all information stored in the first register 0012, and then save an added result into the first register 0012 in time of a rising edge of the second clock signal CLK2.

In time of a next rising edge of the second clock signal CLK2, the most significant bit stored in the first register 0012 will be stored in the second register 0013 and used as a selection signal of the first K-to-1 multiplexer 0031, which is used to select one pulse from the K pulses as the output signal of the first K-to-1 multiplexer 0031.

The second adder 0021 may add a value of the frequency control word F divided by 2 (F/2) and the most significant bits stored in the first register 0012, and then save an added result into the third register 0022 in time of a rising edge of the second clock signal CLK2. In time of a next rising edge of the first clock signal CLK1, information stored in the third register 0022 will be stored in the fourth register 0023 and used as a selection signal of the second K-to-1 multiplexer 0032, which is used to select one pulse from the K pulses as the output signal of the second K-to-1 multiplexer 0032.

In time of a rising edge of the first clock signal CLK1, the 2-to-1 multiplexer 0033 may select one of the output signal from the first K-to-1 multiplexer 0031 and the output signal from the second K-to-1 multiplexer 0032 as the output signal of the 2-to-1 multiplexer 0033 to be used as an input clock signal of the D flip-flop 0041.

One of the output terminal of the D flip-flop 0041 and the output terminal of the second inverter 0043 may be used as an output terminal of the time average frequency-direct period synthesizer.

A selection signal output by the second register 0013 may be used to select a falling edge of a synthesized clock signal generated by the time average frequency-direct period synthesizer. A selection signal output by the fourth register 0023 may be used to select a rising edge of the synthesized clock signal generated by the time average frequency-direct period synthesizer. A signal fed back by the first register 0012 to the first adder 0011 may be used to control period switching of the synthesized clock signal generated by the time average frequency-direct period synthesizer.

The time average frequency-direct period synthesizer generates the intermediate signal based on a time average frequency (TAF). FIG. 9 shows a principle of generating the intermediate signal based on the TAF in some embodiments. Referring to FIGS. 8 and 9, the time average frequency-direct period synthesizer may output the signal with two different periods, and the two periods are a first period T_{A} and a second period T_{B}. As shown in FIG. 9, as for the reference time unit Δ and the frequency control word F=I+r, the first period T_{A} and the second period T_{B} may be expressed by the following formula (1) and formula (2), respectively. Where I is an integer portion of the frequency control word F, and r is a fractional portion of the frequency control word F.

T_{A}=I×Δ (1)

T_{B}=(I+1)×Δ (2)

The clock signal including two different periods (different frequencies) may be generated by using the first period T_{A} and the second period T_{B} in a staggered manner. An average period of the generated clock signal is T_{TAF}, and an average frequency f_{TAF} is shown in the following formula (3).

$${f}_{T A F} = \frac{1}{{T}_{T A F}} = \frac{1}{( I + r ) \times Δ} = \frac{1}{F \times Δ} = \frac{K \times f}{F} \qquad ( 3 )$$

Where f is the frequency of the pulses, and K is the number of the pulses generated by the pulse generation sub-circuit 111. The time average frequency-direct period synthesizer is capable of changing the frequency control word F, and switching of the frequency f_{TAF} of the clock signal generated by the time average frequency-direct period synthesizer may be completed after two periods.

An operation mode of the time average frequency-direct period synthesizer based on the TAF causes a frequency of the output signal to change between two frequencies. Therefore, a phase of the intermediate signal is changeable, and the change of the phase can improve randomness of an output signal of the phase frequency detection sub-circuit 113, thereby further improving the degree of the randomness of the random number.

In some examples, the first frequency divider 1143 is a frequency divider whose frequency division coefficient N is set to a small value, for example, N is equal to 1 (N=1), and may transmit all noise of the pulse generation sub-circuit 111 to the phase frequency detection sub-circuit 113.

In some other examples, the first frequency divider 1143 is a jitter circuit configured to adjust its frequency division coefficient according to a control parameter, so that the randomness of the output signal of the phase frequency detection sub-circuit 113 may be increased.

For example, the control parameter are generated by a parameter generation circuit, and the parameter generation circuit may be a same circuit as the random number generation sub-circuit 115 to take a value of the random number generated by the random number generation sub-circuit 115 as the control parameter. For example, when the random number generation sub-circuit 115 outputs 0, the frequency division coefficient of the first frequency divider 1143 is adjusted to 2; and when the random number generation sub-circuit 115 outputs 1, the frequency division coefficient of the first frequency divider 1143 is adjusted to 1.

For another example, when the random number generation sub-circuit 115 continuously outputs 0 and 0, the frequency division coefficient of the first frequency divider 1143 is adjusted to 2; when the random number generation sub-circuit 115 continuously outputs 0 and 1, the frequency division coefficient of the first frequency divider 1143 is adjusted to 1; and when the random number generation sub-circuit 115 continuously outputs 1 and 0, the frequency division coefficient of the first frequency divider 1143 is adjusted to 3. Of course, the parameter generation circuit may also be a circuit other than the random number generation sub-circuit 115.

In some embodiments described above, the phase relationship indicating signal is a digital signal, and the random number is expressed as binary numbers obtained by combining values of a plurality of phase relationship indicating signals. It will be noted that, in the embodiments of the present disclosure, a certain signal being 0 means that a value of the signal is 0, and a certain signal being 1 means that a value of the signal is 1.

For example, the value of the phase relationship indicating signal is 0 or 1; in the case where the value of the phase relationship indicating signal is 0, it indicates that the phase of the input signal lags behind the phase of the feedback signal; and in the case where the value of the phase relationship indicating signal is 1, it indicates that the phase of the input signal leads the phase of the feedback signal.

For example, within a predetermined period of time, the phase frequency detection sub-circuit 113 performs phase comparisons for m (e.g., m is equal to 10 (m=10)) times to generate m phase relationship indicating signals. Values of the m phase relationship indicating signals are 0, 1, 1, 0, 0, 1, 1, 1, 1 and 0, and then a digital signal sequence composed of the values of the m phase relationship indicating signals constitutes the random number, i.e., 0110011110. It can be understood that, m=10 is merely an exemplary illustration. In practical applications, m may be a larger value to generate the random number with more digits, e.g., 64 digits, 128 digits or 256 digits, thereby increasing complexity of the random number generated by the random number generation sub-circuit 115.

In the embodiments of the present disclosure, each part of the random number generator 11 is a digital circuit, and has characteristics of low power consumption and low cost, which facilitates integration in various chips. Moreover, the degree of the randomness of the random number generated by the random number generator 11 is high, which can provide higher security and reliability in a communication process.

In some embodiments, referring to FIG. 11, the optical signal receiver 200 includes a second key manager 22, a visible light receiver 27 and a second encryption and decryption device 23.

The second key manager 22 is capable of storing and managing various types of keys required by the optical signal receiver 200, which include, for example, a third key generated therein, and a fourth key obtained from an outside.

The visible light receiver 27 is configured to receive second visible light, and decode the second visible light into second encrypted data. For example, the visible light receiver 27 is a photoelectric sensor, an image sensor, or an electronic device including a photoelectric sensor or an image sensor. The visible light receiver 27 is capable of decoding the visible light it receives into data and output the data.

The second encryption and decryption device 23 is connected to the second key manager 22 and the visible light receiver 27. The second encryption and decryption device 23 is configured to decrypt the fourth key according to the third key to obtain a fifth key, and decrypt the second encrypted data according to the fifth key to obtain initial communication data.

For example, as shown in FIG. 11, the second key manager 22 includes a second memory 221 and a third key generator 222. The third key generator 222 is configured to generate the third key. The second memory 221 is configured to store and manage the third key and the fourth key.

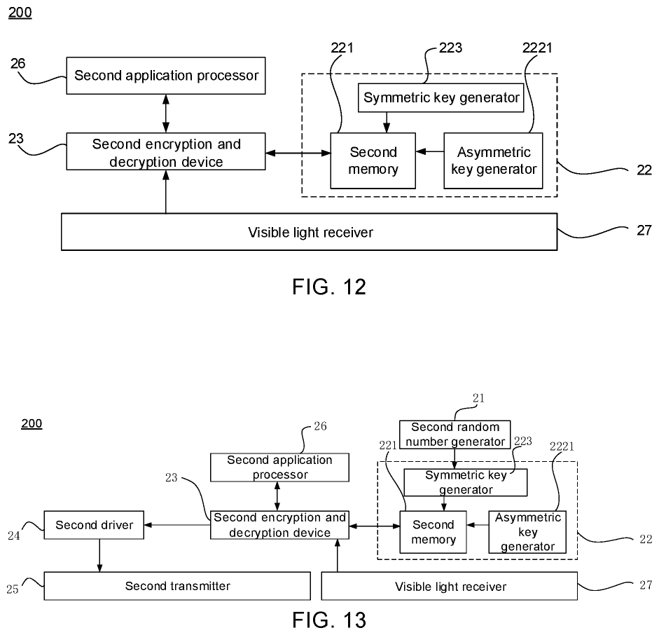

In some examples, referring to FIG. 12, the third key is an asymmetric key, and the third key generator 222 is an asymmetric key generator 2221. The third key includes a first public key and a first private key, and the first public key and the first private key are used in pair. The fourth key is a key obtained by encrypting the fifth key with the first public key. The second encrypted data is data obtained by encrypting the initial communication data with the fifth key. The second encryption and decryption device is configured to decrypt the fourth key according to the first private key.

On this basis, optionally, the second key manager 22 further includes a symmetric key generator 223 configured to generate a symmetric key.

In some other examples, the third key is a symmetric key, and the third key generator 222 is a symmetric key generator. The fourth key is a key obtained by encrypting the fifth key with the third key. The second encrypted data is data obtained by encrypting the initial communication data with the fifth key.

On this basis, optionally, the second key manager 22 further includes an asymmetric key generator configured to generate an asymmetric key.

By providing the symmetric key generator and the asymmetric key generator in the second key manager 22 of the optical signal receiver 200, it is possible to facilitate communications between the optical signal receiver 200 and both the optical signal transmitter 100 and an external communication device by using a plurality of different encryption methods.

In some examples, the second encryption and decryption device 23 is an encryption chip. The second encryption and decryption device 23 is capable of receiving the decoded data transmitted by the visible light receiver 27 or an application request, and calling the keys from the second key manager 22 to perform an encryption or decryption operation.

It will be added that, in the optical signal receiver 200 shown in FIGS. 11 and 12, the optical signal receiver 200 further includes a second application processor 26. The second application processor 26 is connected to an application interface, and can receive an application request and perform information interaction with the external communication device. Here, the application interface includes a hardware interface, e.g., a USB interface, and/or, the application interface includes a software interface, e.g., a user interface in an operating system. The second application processor 26 is also connected to the second encryption and decryption device 23, and is capable of achieving bidirectional information interaction with the second encryption and decryption device 23.

In some other embodiments, referring to FIG. 13, the optical signal receiver 200 further includes a second random number generator 21, a second driver 24 and a second transmitter 25. The second random number generator 21 is connected to the symmetric key generator 223 in the second key manager 22. In this way, the symmetric key in the second key manager 22 may be generated based on a random number generated by the second random number generator 21. The second random number generator 21 may have the same structure as the first random number generator 11 to ensure that the random number generated by the second random number generator 21 has extremely high uncertainty, thereby ensuring that the symmetric key has high randomness. The second driver 24 is connected to the second transmitter 25 and the second encryption and decryption device 23. The second driver 24 is capable of encoding encrypted data transmitted by the second encryption and decryption device 23 into a visible light emission instruction, thereby driving the second transmitter 25 to emit visible light according to the visible light emission instruction. The second driver 24 may have the same structure as the first driver 14. The second transmitter 25 may have the same structure as the first transmitter 15. In this way, the optical signal receiver 200 in the embodiments of the present disclosure has two functions of transmitting and receiving optical signals.

It will be noted that, the application processor involved in some embodiments described above may be a central processing unit (CPU), or may be any other general-purpose processor, a digital signal processor (DSP), an application-specific integrated circuit (ASIC), a field programmable gate array (FPGA), or any other programmable logic device, a discrete gate or a transistor logic device, a discrete hardware component, etc. The general-purpose processor may be a microprocessor or any conventional processor or the like.

The memory involved in some embodiments described above may be a read-only memory (ROM) or a static storage device of any other type that may store static information and instructions, a random access memory (RAM) or a dynamic storage device of any other type that may store information and instructions, or an electrically erasable programmable read-only memory (EEPROM), a compact disc read-only memory (CD-ROM) or any other compact disc storage, optical disc storage (including a compressed disc, a laser disc, an optical disc, a digital versatile disc or a Blu-ray disc), a magnetic disc storage medium or any other magnetic storage device, or any other medium that can be used to carry or store desired program codes in a form of instructions or data structures and that can be accessed by a computer, but it is not limited thereto.

Devices (the random number generator(s), the key manager, the encryption and decryption device(s), the driver(s), and the application processor) in a same optical communication apparatus involved in some embodiments described above may be integrated in one processor, or each device physically exist alone, or two or more devices are integrated in one unit. The above integrated unit may be in a form of hardware or in a form of software.

Referring to FIG. 15, in the optical communication system 1000 provided in some embodiments, the optical signal transmitter 100 and the optical signal receiver 200 are disposed opposite to each other, and an optical signal collection region of the optical signal receiver 200 may cover a light-emitting region of the optical signal transmitter 100. The first visible light emitted by the optical signal transmitter 100 and the second visible light received by the optical signal receiver 200 are the same visible light. Correspondingly, the second encrypted data and the first encrypted data are the same encrypted data. The optical signal transmitter 100 and the optical signal receiver 200 are in near field communication.

In the present embodiments, the first key in the optical signal transmitter 100 and the fifth key in the optical signal receiver 200 are the same key. The first encrypted key in the optical signal transmitter 100 and the fourth key in the optical signal receiver 200 are the same key.

In a case where the third key in the optical signal receiver 200 is the asymmetric key, the second key in the optical signal transmitter 100 and the first public key of the third key in the optical signal receiver 200 are the same key.

In a case where the third key in the optical signal receiver 200 is the symmetric key, the second key in the optical signal transmitter 100 and the third key in the optical signal receiver 200 are the same key. The third key may be copied into the optical signal transmitter 100 through a removable storage device.

When the optical communication system 1000 shown in FIG. 15 is used to perform an optical communication method, the optical communication method includes S100 to S800.

In S100, the second key manager 22 stores and manages the third key.

The third key is the symmetric key or the asymmetric key. The third key that is the symmetric key or the first public key of the third key that is the asymmetric key may be transmitted to the optical signal transmitter 100 through a removable storage device, a wireless network, a wired network, etc.

Here, the third key in the second key manager 22 may be generated autonomously according to an application request.

In S200, the first key manager 12 obtains and stores the third key that is the symmetric key or the first public key of the third key that is the asymmetric key, and manages the third key that is the symmetric key or the first public key of the third key that is the asymmetric key as the second key.

Optionally, the third key that is the symmetric key or the first public key of the third key that is the asymmetric key is transmitted to the first application processor 16 in the optical signal transmitter 100, and then is stored in the first memory 121 of the first key manager 12 through the first application processor 16. Or, the third key that is the symmetric key or the first public key of the third key that is the asymmetric key is directly stored in the first memory 121 of the first key manager 12.

In S300, the random number generator 11 in the optical signal transmitter 100 generates the random number based on the time frequency. The first key manager 12 obtains the random number and generates the first key according to the random number. The first key manager 12 stores and manages the first key.

In S400, the first encryption and decryption device 13 encrypts the first key according to the second key to obtain the first encrypted key.

After an application request is input to the optical signal transmitter 100, the first encryption and decryption device 13 is capable of calling the first key and the second key from the first key manager 12 to perform an encryption operation.

Here, the first encrypted key may be transmitted to the optical signal receiver 200 through a removable storage device, a wireless network, a wired network, or the like.

In S500, the second key manager 22 stores the first encrypted key and manages the first encrypted key as the fourth key.

Optionally, the first encrypted key is transmitted to the second application processor 26 in the optical signal receiver 200, and then is stored in the second memory 221 of the second key manager 22 through the second application processor 26. Or, the first encrypted key is directly stored in the second memory 221 of the second key manager 22.

In S600, the second encryption and decryption device 23 decrypts the fourth key according to the third key that is the symmetric key or the first private key of the third key that is the asymmetric key to obtain the first key. The second key manager 22 stores the first key and manages the first key as the fifth key.

The second encryption and decryption device 23 is capable of calling the fourth key and the third key from the second memory 221 to decrypt the fourth key by using the third key that is the symmetric key or the first private key of the third key that is the asymmetric key to obtain the first key.

In S700, the first encryption and decryption device 13 decrypts the initial communication data according to the first key to obtain the encrypted data. The driver 14 receives the encrypted data and encodes the encrypted data into the visible light emission instruction. The transmitter 15 receives the visible light emission instruction, and emits the visible light according to the visible light emission instruction.

After the optical signal receiver 200 stores the first key, the optical signal transmitter 100 encrypts the initial communication data to be transmitted and encodes the encrypted data into the visible light emission instruction, and may emit the visible light according to the visible light emission instruction, thereby completing the function of transmitting the optical signal of the optical signal transmitter 100.

Here, the visible light emission instruction includes at least one of the brightness instruction, the gray-scale instruction, the frequency instruction, the color instruction, or the light-emitting area instruction, and different control signals in each instruction are used to characterize different data. For example, the visible light emission instruction is the gray-scale instruction. In this way, by controlling the gray scale to change through different gray-scale instructions, transmission of different data may be correspondingly achieved. For example, the visible light emission instruction is the frequency instruction. In this way, by controlling a light-emitting frequency of the light-emitting device to change through different frequency instructions, transmission of different data may be correspondingly achieved.

The first encryption and decryption device 13 may encrypt the initial communication data according to the first key by using at least one of an advanced encryption standard (abbreviated as AES), a data encryption algorithm (abbreviated as DEA), a triple data encryption algorithm (abbreviated as TDEA) or a secure hash algorithm (abbreviated as SHA), but it is not limited thereto.

In S800, the visible light receiver 27 receives the visible light, and decodes the visible light into the encrypted data. The second encryption and decryption device 23 decrypts the encrypted data according to the fifth key to obtain the initial communication data.

After receiving the visible light emitted by the optical signal transmitter 100, the optical signal receiver 200 is capable of decrypting the encrypted data by using the first key, thereby obtaining the initial communication data.

Hitherto, the encrypted transmission of the data by the optical communication system 1000 is completed.

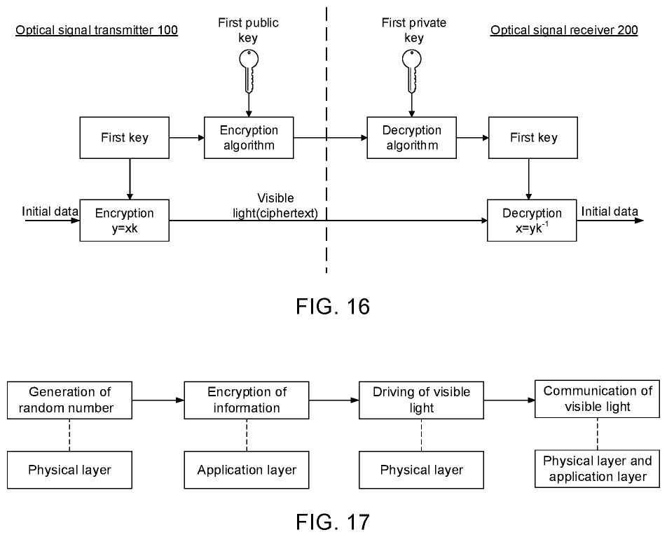

In order to more clearly illustrate transmission paths of the initial communication data and the first key in the above optical communication method, the following takes an example in which the second key is the first public key of the third key for illustration. In this method, the transmission paths of the initial communication data and the first key between the optical signal transmitter 100 and the optical signal receiver 200 are shown in FIG. 16. After the first key is encrypted by using the first public key, the first encrypted key is transmitted to the optical signal receiver 200 in a wireless transmission manner, and then the first encrypted key is decrypted by using the first private key to obtain the first key. After the initial communication data is encrypted by using the first key, the encrypted initial communication data may be transmitted to the optical signal receiver 200 in a form of visible light, and then the encrypted initial communication data is decrypted by using the first key to obtain the initial communication data.

A network hierarchy at which part of the steps in the above optical communication method are performed is shown in FIG. 17. The generation of the random number is performed at a physical layer, and the encryption of the first key and the encryption of the initial communication data are performed at an application layer. The encrypted initial communication data is transmitted at the physical layer in the form of visible light. The reception of the visible light is performed at the physical layer, and the decoding and the decryption of the visible light are performed at the application layer.

In the embodiments of the present disclosure, the first encrypted key and the first encrypted data are encrypted by using different keys, and are transmitted in different transmission manners, so that multiple encryption guarantees of the data in the physical layer and the application layer may be achieved, thereby effectively improving the reliability and the confidentiality of the data in the whole transmission process, and enhancing the communication security of the data. In addition, the first key is generated by the random number generator, which has advantages of low cost, low power consumption, high reliability and difficult cracking, etc., and can further guarantee the communication security of the data.

In some embodiments described above, the first encrypted key, the third key that is the symmetric key, or the first public key of the third key that is the asymmetric key may be transmitted by using any one of the following communication protocols: wireless fidelity (WIFI), wireless mesh network, Bluetooth, ZigBee (low-power consumption local area network protocol based on IEEE802.15.4 standard), Z-Wave, near field communication (NFC) or ultra-wideband (UWB), but it is not limited thereto.

In some embodiments, the structure of the random number generator 11 is shown in FIG. 4. S300, in which the random number generator 11 generates the random number based on the time frequency, includes S310 to S330.

In S310, the pulse generation sub-circuit 111 generates the plurality of pulses, and the frequency of the pulses changes with the changes in the environmental parameter.

In S320, the phase frequency detection sub-circuit 113 generates the phase relationship indicating signal and the frequency relationship indicating signal according to the relationship between the phase of the input signal and the phase of the feedback signal. The phase relationship indicating signal indicates whether the phase of the input signal leads the phase of the feedback signal. The frequency relationship indicating signal indicates the relationship between the magnitude of the frequency of the input signal and the magnitude of the frequency of the feedback signal. The feedback signal is generated by the feedback sub-circuit 114 according to the frequency relationship indicating signal and the frequency of the pulses.

For example, the phase relationship indicating signal is obtained by processing the output signals of the first output terminal out1 and the second output terminal out2 of the phase frequency detection sub-circuit 113 shown in FIG. 6 according to the first logic rule. The output signal of the first output terminal out1, the output signal of the second output terminal out2, and the phase relationship indicating signal are all digital signals. For example, the value of the first digital signal is 1, and the value of the second digital signal is 0. The first rule is that: in the case where the value of the output signal of the first output terminal out1 is 1, and the value of the output signal of the second output terminal out2 is 0, the value of the phase relationship indicating signal is 1; in the case where the value of the output signal of the first output terminal out1 is 0, and the value of the output signal of the second output terminal out2 is 1, the value of the phase relationship indicating signal is 0; and in the case where the value of the output signal of the first output terminal out1 and the value of the output signal of the second output terminal out2 are both 1 or 0, they are discarded. In the case where the value of the phase relationship indicating signal is 1, it indicates that the phase of the input signal leads the phase of the feedback signal; and in the case where the value of the phase relationship indicating signal is 0, it indicates that the phase of the input signal lags behind the phase of the feedback signal.

The 0/1 bit stream output by the phase frequency detection sub-circuit 113 has no periodicity and no characteristic data blocks, and within a period of time, probabilities of 0 and 1 output thereby are each close to 50%, and 0 and 1 output thereby have good randomness.

In some examples, a method for generating the feedback signal includes S321 to S323.

In S321, the controller 1141 generates the frequency control word according to the frequency relationship indicating signal.

For example, before S321, the initial frequency control word is obtained. In the case where the frequency relationship indicating signal indicates that the frequency fi of the input signal Fi is greater than the frequency fb of the feedback signal Fb, the controller 1141 reduces the current frequency control word by one; and in the case where the frequency relationship indicating signal indicates that the frequency of the input signal Fi is less than the frequency of the feedback signal Fb, the controller 1141 increases the current frequency control word by one.

In S322, the digitally controlled oscillator 1142 generates the intermediate signal according to the frequency control word and the frequency of the pulses.

Here, the frequency of the intermediate signal is

$$K \times \frac{f}{F} ,$$

where K is the number of the pulses generated by the pulse generation sub-circuit 111, f is the frequency of the pulses, and F is the frequency control word.

In S323, the first frequency divider divides the frequency of the intermediate signal to generate the feedback signal.

For example, the frequency division coefficient by which the first frequency divider 1143 divides the frequency of the intermediate signal is 1.

For example, S323 includes: adjusting the frequency division coefficient according to the control parameter, and dividing the frequency of the intermediate signal by using the adjusted frequency division coefficient.

In S330, the random number generator 115 generates the random number according to the phase relationship indicating signal.

In some examples, the phase relationship indicating signal is a digital signal, and the random number is expressed as a digital signal sequence formed based on a combination of a plurality of phase relationship indicating signals. For example, the value of the phase relationship indicating signal is 0 or 1. In the case where the value of the phase relationship indicating signal is 0, it indicates that the phase of the input signal lags behind the phase of the feedback signal. In the case where the value of the phase relationship indicating signal is 1, it indicates that the phase of the input signal leads the phase of the feedback signal.

For example, within a predetermined period of time, the phase frequency detection sub-circuit 113 performs phase comparisons for m (e.g., m is equal to 10 (m=10)) times to generate m phase relationship indicating signals. Values of the m phase relationship indicating signals are 0, 1, 1, 0, 0, 1, 1, 1, 1 and 0, and then a digital signal sequence composed of the values of the m phase relationship indicating signals constitutes a random number, i.e., 0110011110. It can be understood that, m=10 is merely an exemplary illustration. In practical applications, m may be a larger value to generate the random number with more digits, e.g., 64 digits, 128 digits or 256 digits, thereby increasing the degree of the randomness of the random number generated by the random number generation sub-circuit 115.

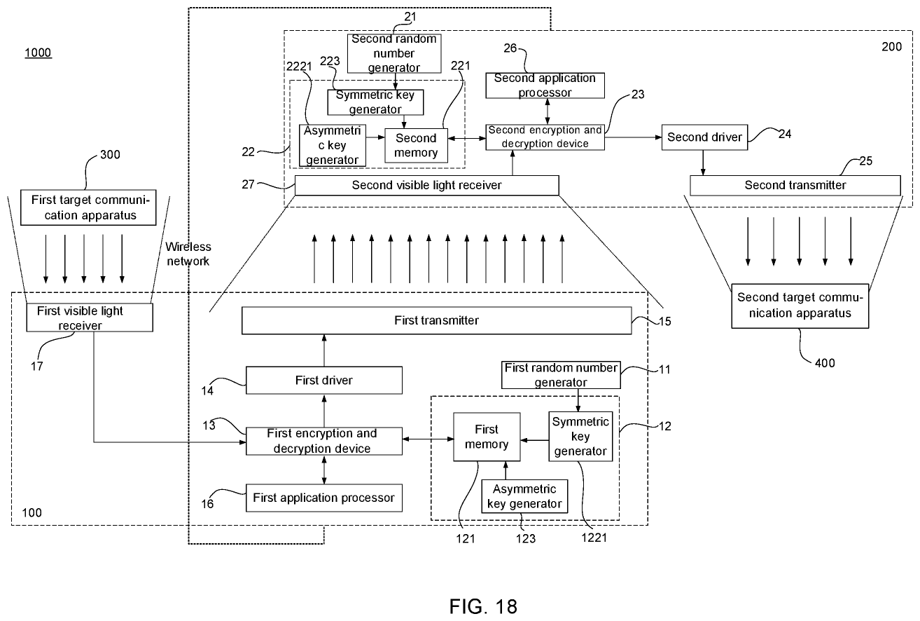

In some other embodiments, as shown in FIG. 18, the optical signal transmitter 100 and the optical signal receiver 200 each have two functions of transmitting and receiving the optical signals. For implementation of the function of transmitting the optical signal of the optical signal transmitter 100 and implementation of the function of receiving the optical signal of the optical signal receiver 200, reference may be made to the related records in some embodiments described above, and details will not be repeated herein.

Here, the optical signal transmitter 100 may also be used as an optical signal receiver of a first target communication apparatus 300, and its function of receiving an optical signal is the same as the function of receiving the optical signal of the optical signal receiver 200, and for implementation of its function, reference may be made to the related records in some embodiments described above. Here, a key for decrypting data transmitted by the first target communication apparatus 300 in the optical signal transmitter 100 is set to be matched with a key for encrypting the transmitted data in the first target communication apparatus 300. The first target communication apparatus 300 may have the same structure as the optical signal transmitter 100 in some embodiments.

The optical signal receiver 200 may also be used as an optical signal transmitter of a second target communication apparatus 400, and its function of transmitting an optical signal is the same as the function of transmitting the optical signal of the optical signal transmitter 100, and for implementation of its function, reference may be made to the related records in some embodiments described above. Here, a key for encrypting transmitted data in the optical signal receiver 200 is set to be matched with a key for decrypting the data transmitted by the optical signal receiver 200 in the second target communication apparatus 400. The second target communication apparatus 400 may have the same structure as the optical signal receiver 200 in some embodiments.

In the embodiments of the present disclosure, the optical communication system 1000 is capable of implementing encrypted communication between multiple optical communication apparatuses, and has high use reliability, and is beneficial to guaranteeing the communication security of the data.

In order to more clearly illustrate the encrypted transmission process of the initial communication data in the optical communication method, the following takes an example in which the first encryption and decryption device 13 encrypts the initial communication data by using a multiplication operation for illustration.

Referring to FIGS. 15 and 16, in a process of encrypting the initial communication data by the first encryption and decryption device 13 according to the first key, the encryption operation may be implemented by using various algorithms. For example, a data length of the initial communication data is 64 digits. The first key is a symmetric key k, and its length is also 64 digits. The process of encrypting the initial communication data by the first encryption and decryption device 13 according to the first key is expressed by the following formula (4).

y=x×k (4)

Where x is the initial communication data, k is the first key, and y is the first encrypted data.

For example, x=50, k=321561, and then y=50×321561=16078050.

Since the first key k is generated based on the random number generated by the random number generator 11, the first key k has extremely high uncertainty. In this way, after the first encrypted data is transmitted, there is no fear that the first encrypted data is stolen even in an insecure transmission channel, since a stealer cannot crack what the initial communication data is without knowing the first key k. Of course, the first encryption and decryption device 13 may also encrypt the initial communication data by using a more complex algorithm according to the first key k.

After receiving the first encrypted data y, the driver 14 may encode the first encrypted data y into the visible light emission instruction. For example, as shown in FIG. 10, the transmitter 15 is a display screen including a plurality of pixels 151 arranged in an array. The visible light emission instruction obtained through the encoding by the driver 14 is, for example, a pixel gray-scale or a light-emitting frequency.

In some examples, the visible light emission instruction is a pixel gray-scale instruction. For example, the first encrypted data y (16078050) is first converted to a binary number 111101010100100100101010, which has a digit length of 24 digits. Based on that the data length is 64 digits, a binary number corresponding to the first encrypted data y may be expressed as: 40 digits of 0+the above 24-digit number. Based on that a gray scale of a display screen typically has 256 levels, if a data length characterized by each level of the gray scale is set to 8 digits, then the 64-digit number of the first encrypted data y needs to be transmitted for 8 (64/8=8) times. Therefore, starting from low digits, the first encrypted data y may be converted into 8 gray-scale instructions, which are L42 (00101010), L73 (01001001), L245 (11110101), LO, LO, LO, LO and LO. In this way, conversion between an electrical signal and an optical signal is achieved through the gray-scale instructions.

After receiving the visible light emission instruction transmitted by the driver 14, the display screen may emit the visible light according to the visible light emission instruction to achieve optical communication. Since brightness of the visible light is easy to attenuate with an increase of a propagation distance of the visible light, and it attenuates fast, by using the visible light to perform the data communication, it is able to effectively guarantee a secure communication of the data, and it is applicable to the near field communication.

The visible light receiver 27 in the optical signal receiver 200 is directly opposite to the display screen, and is capable of accurately collecting the visible light, and decoding the visible light to obtain the first encrypted data y. Levels of the gray scale of the visible light received by the visible light receiver 27 are L42, L73, L245, LO, LO, LO, LO and LO, and after the visible light is decoded, the first encrypted data y is 111101010100100100101010.

The second encryption and decryption device 23 calls the first key k that has been stored (for its storage process, reference may be made to the above related records, and details will not be repeated herein) from the second key manager 33, and the first key k may be used to perform an inverse operation, which is expressed by the following formula (5).

x=y×k⁻¹ (5)

The initial communication data x obtained after calculation is 50 (16078050/321561=50). The initial communication data x may be securely obtained through implementation of the above steps.

The optical communication system and the optical communication method in some embodiments described above may be applied to multiple daily communication scenarios.

For example, on a shoppable interface where multiple commodities are displayed, payment information of each commodity may be emitted in the form of visible light. Since information of the visible light for characterizing the first encrypted data is the gray scale, the frequency, etc., its existence does not affect a user viewing a displayed picture of the commodity. When the user directly takes a displayed picture of a commodity that he or she wants to purchase by using an electronic device with a function of receiving visible light (e.g., a mobile phone), the electronic device may directly decode implicit information, i.e., payment information of the commodity, thereby directly making a payment or jumping to a payment interface to complete a payment operation. This can omit further operation of the user on the shoppable interface, such as clicking the picture of the commodity to enter a payment information display interface, and effectively simplify a purchase process of the user and also ensures the secure communication of the encrypted data.

For example, on a user display interface, a watermark or other links that can be used for copyright protection is emitted in the form of visible light Since information of the visible light for characterizing the first encrypted data is the gray scale, the frequency, etc., its existence does not affect original display of the display interface. In this way, when another person photographs the display interface with an electronic device with a function of receiving visible light (e.g., a mobile phone), the first encrypted data may be decoded and decrypted in image information obtained by the electronic device, so that the watermark or other links that can be used for the copyright protection can be displayed in a picture output by the electronic device, and information displayed on the user display interface is protected.

Some embodiments of the present disclosure provide a computer-readable storage medium (e.g., a non-transitory computer-readable storage medium) in which computer program instructions are stored. The computer-readable storage medium stores computer program instructions that, when running in an optical communication system, cause the optical communication system to perform one or more steps of the optical communication method as described in any one of the above embodiments.

For example, the computer-readable storage medium may include, but is not limited to, a magnetic storage device (e.g., a hard disk, a floppy disk or a magnetic tape), an optical disk (e.g., a compact disk (CD)), a digital versatile disk (DVD), a smart card or a flash memory device (e.g., an erasable programmable read-only memory (EPROM)). Various computer-readable storage media described in the present disclosure may represent one or more devices and/or other machine-readable storage media for storing information. The term “machine-readable storage media” may include, but is not limited to, wireless channels and other various media capable of storing, containing and/or carrying instructions and/or data.

Some embodiments of the present disclosure provide a computer program. When running in an optical communication system, the computer program causes the optical communication system to perform one or more steps of the optical communication method as described in any one of the above embodiments.

Beneficial effects of the computer-readable storage medium and the computer program are the same as those of the optical communication method as described in some embodiments described above, and details will be not repeated herein.

In the description of the above embodiments, the specific features, structures, materials or characteristics may be combined in any one or more embodiments or examples in any suitable manner.

The foregoing descriptions are merely specific implementations of the present disclosure, but the protection scope of the present disclosure is not limited thereto. Any person skilled in the art could conceive of changes or replacements within the technical scope disclosed in the present disclosure, which shall all be included in the protection scope of the present disclosure. Therefore, the protection scope of the present disclosure shall be subject to the protection scope of the claims.

1. An optical communication apparatus, comprising:
a random number generator configured to generate a random number based on a time frequency;
a first key manager configured to generate a first key based on the random number, store and manage the first key and an obtained second key;
a first encryption and decryption device connected to the first key manager, and configured to encrypt the first key according to the second key to obtain a first encrypted key, and configured to encrypt initial communication data according to the first key to obtain first encrypted data;
a driver connected to the first encryption and decryption device, and configured to obtain the first encrypted data and encode the first encrypted data into a visible light emission instruction; and
a transmitter connected to the driver, and configured to receive the visible light emission instruction and emit first visible light according to the visible light emission instruction.

2. The optical communication apparatus according to claim 1, wherein the random number generator includes a pulse generation sub-circuit, a frequency locked loop and a random number generation sub-circuit;
the pulse generation sub-circuit is configured to generate a plurality of pulses, and a frequency of the pulses changes with changes in an environmental parameter;
the frequency locked loop includes a phase frequency detection sub-circuit and a feedback sub-circuit; the phase frequency detection sub-circuit is configured to generate a phase relationship indicating signal and a frequency relationship indicating signal according to a relationship between a phase of an input signal and a phase of a feedback signal, the phase relationship indicating signal indicates whether the phase of the input signal leads the phase of the feedback signal, and the frequency relationship indicating signal indicates a relationship between a magnitude of a frequency of the input signal and a magnitude of a frequency of the feedback signal; and the feedback sub-circuit is configured to generate the feedback signal according to the frequency relationship indicating signal and the frequency of the pulses; and
the random number generation sub-circuit is configured to generate the random number according to the phase relationship indicating signal.

3. The optical communication apparatus according to claim 2, wherein the feedback sub-circuit includes:
a controller configured to generate a frequency control word according to the frequency relationship indicating signal;
a digitally controlled oscillator configured to generate an intermediate signal according to the frequency control word and the frequency of the pulses, a frequency of the intermediate signal being
$$K \times \frac{f}{F} ,$$
wherein K is a number of the pulses generated by
the pulse generation sub-circuit, f is the frequency of the pulses, and F is the frequency control word; and
a first frequency divider configured to divide the frequency of the intermediate signal to generate the feedback signal.

4. The optical communication apparatus according to claim 2, wherein the random number generator further includes an input device configured to transmit the input signal; and the input device includes a crystal oscillator, a micro-electro-mechanical system or an oscillator.

5. The optical communication apparatus according to claim 1, wherein the first key manager includes:
a first key generator configured to obtain the random number and generate the first key; and
a first memory configured to store and manage the first key and the second key.

6. An optical communication apparatus, comprising:
a second key manager configured to store and manage a third key and a fourth key obtained from an outside;
a visible light receiver configured to receive second visible light and decode the second visible light into second encrypted data; and
a second encryption and decryption device connected to the second key manager and the visible light receiver, the second encryption and decryption device being configured to decrypt the fourth key according to the third key to obtain a fifth key, and decrypt the second encrypted data according to the fifth key to obtain initial communication data.

7. The optical communication apparatus according to claim 6, wherein the second key manager includes:
a third key generator configured to generate the third key; and
a second memory configured to store and manage the third key and the fourth key, wherein the third key is one of an asymmetric key and a symmetric key;
the third key is the asymmetric key, the third key includes a first public key and a first private key, and the first public key and the first private key are used in pair, wherein the fourth key is a key obtained by encrypting the fifth key with the first public key; the second encrypted data is data by encrypting the initial communication data with the fifth key; and the second encryption and decryption device is configured to decrypt the fourth key according to the first private key; or
the third key is the symmetric key, the fourth key is a key obtained by encrypting the fifth key with the third key; and the second encrypted data is data obtained by encrypting the initial communication data with the fifth key.

8. The optical communication apparatus according to claim 6, wherein the visible light receiver includes a photoelectric sensor or an image sensor.

9. An optical communication system, comprising an optical signal transmitter and an optical signal receiver,
the optical signal transmitter including a first optical communication apparatus, wherein the first optical communication apparatus is the optical communication apparatus according to claim 1; and
the optical signal receiver including a second optical communication apparatus, wherein the second optical communication apparatus includes:
a second key manager configured to store and mange a third key and a fourth key obtained from an outside;
a visible light receiver configured to receive a second visible light and decode the second visible light into a second encrypted data, the first visible light and the second visible light being same visible light, and the first encrypted data and the second encrypted data being same encrypted data; and
a second encryption and decryption device connected to the second key manager and the visible light receiver, the second encryption and decryption device being configured to decrypt the fourth key according to the third key to obtain a fifth key, and decrypt the second encrypted data according to the fifth key to obtain the initial communication data, wherein
the first key in the optical signal transmitter and the fifth key in the optical signal receiver are a same key;
the first encrypted key in the optical signal transmitter and the fourth key in the optical signal receiver are a same key; and
the second key in the optical signal transmitter is one of a first public key of the third key that is asymmetric key and the third key that is a symmetric key in the optical signal receiver.

10. The optical communication system according to claim 9, wherein
the optical signal receiver further includes a third optical communication apparatus, and the third optical communication apparatus includes:
another random number generator configured to generate a random number based on a time frequency;
another first key manager configured to generate a first key based on the random number generated by the another random number generator, store and manage the first key generated by the another first key manager and an obtained second key;
another first encryption and decryption device connected to the another first key manager, and configured to encrypt the first key generated by the another first key manager according to the second key store in the another first key manager to obtain a first encrypted key, and configured to encrypt initial communication data according to the first key generated by the another first key manger to obtain third encrypted data;
another driver connected to the another first encryption and decryption device, and configured to obtain the third encrypted data end encode the third encrypted data into a visible light emmission instruction; and
another transmitter connected to the another driver, and configured to receive the visible light emission instruction encoded by the another driver and emit third visible light according to the visible light emission instruction encoded by the another driver.

11. An optical communication method applied to the optical communication system according to claim 9, the optical communication method comprising:
storing and managing, by the second key manager, the third key;
obtaining and storing, by the first key manager, the third key that is the symmetric key or the first public key of the third key that is the asymmetric key;
managing, by the first key manager, the third key that is the symmetric key or the first public key of the third key that is the asymmetric key as the second key;
generating, by the random number generator, the random number based on the time frequency;
obtaining, by the first key manager, the random number;
generating, by the first key manager, the first key according to the random number;
storing and managing, by the first key manager, the first key;
encrypting, by the first encryption and decryption device, the first key according to the second key to obtain the first encrypted key;
storing, by the second key manager, the first encrypted key;
managing, by the second key manager, the first encrypted key as the fourth key;
decrypting, by the second encryption and decryption device, the fourth key according to the third key that is the symmetric key or a first private key of the third key that is the asymmetric key to obtain the first key;
storing, by the second key manager, the first key;
managing, by the second key manager, the first key as the fifth key;
encrypting, by the first encryption and decryption device, the initial communication data according to the first key to obtain the encrypted data;
receiving, by the driver, the encrypted data;
encoding, by the driver, the encrypted data into the visible light emission instruction;
receiving, by the transmitter, the visible light emission instruction;
emitting, by the transmitter, the visible light according to the visible light emission instruction;
receiving, by the visible light receiver, the visible light;
decoding, by the visible light receiver, the visible light into the encrypted data; and
decrypting, by the second encryption and decryption device, the encrypted data according to the fifth key to obtain the initial communication data.

12. The optical communication method according to claim 11, wherein the random number generator includes a pulse generation sub-circuit, a frequency locked loop and a random number generation sub-circuit, and the frequency locked loop includes a phase frequency detection sub-circuit and a feedback sub-circuit;
generating, by the random number generator, the random number based on the time frequency includes:
generating, by the pulse generation sub-circuit, a plurality of pulses, a frequency of the pulses changing with changes in an environmental parameter;
generating, by the phase frequency detection sub-circuit, a phase relationship indicating signal and a frequency relationship indicating signal according to a relationship between a phase of an input signal and a phase of a feedback signal, the phase relationship indicating signal indicating whether the phase of the input signal leads the phase of the feedback signal, and the frequency relationship indicating signal indicating a relationship between a magnitude of a frequency of the input signal and a magnitude of a frequency of the feedback signal; and the feedback signal being generated by the feedback sub-circuit according to the frequency relationship indicating signal and the frequency of the pulses; and
generating, by the random number generation sub-circuit, the random number according to the phase relationship indicating signal.

13. The optical communication method according to claim 12, wherein the feedback sub-circuit includes a controller, a digitally controlled oscillator, and a first frequency divider;
the feedback signal is generated according to following steps:
a frequency control word is generated by the controller according to the frequency relationship indicating signal;
an intermediate signal is generated by the digitally controlled oscillator according to the frequency control word and the frequency of the pulses, and a frequency of the intermediate signal is
$$K \times \frac{f}{F} ,$$
wherein K is a number of the pulses generated by the pulse generation sub-circuit, f is the frequency of the pulses, and F is the frequency control word; and
the frequency of the intermediate signal is divided by the first frequency divider to generate the feedback signal.

14. The optical communication method according to claim 11, wherein the first encrypted key, the third key that is the symmetric key or the first public key of the third that is the asymmetric key are transmitted by using any one of following communication protocols:
wireless fidelity (WIFI), wireless mesh network, Bluetooth, ZigBee, Z-Wave, near field communication (NFC) or ultra-wideband (UWB).

15. The optical communication method according to claim 11, wherein the visible light emission instruction includes at least one of a brightness instruction, a gray-scale instruction, a frequency instruction, a color instruction or a light-emitting area instruction.

16. A non-transitory computer-readable storage medium, wherein the computer-readable storage medium stores computer program instructions that, when running in an optical communication system, cause the optical communication system to perform one or more steps of the optical communication method according to claim 11.

17. The optical communication system according to claim 9, wherein
the optical signal transmitter further includes a fourth optical communication apparatus, and the fourth optical communication apparatus includes:
another second key manager configured to store and manage a third key and a fourth key obtained from an outside;
another visible light receiver configured to receive fourth visible light and decode the fourth visible light into fourth encrypted data; and
another second encryption and decryption device connected to the another second key manager and the another visible light receiver, the another second encryption and decryption device being configured to decrypt the fourth key stored in the another second key manager according to the third key stored in the another second key manager to obtain a fifth key, and decrypt the fourth encrypted data according to the fifth key obtained by the another second encryption and decryption device to obtain initial communication data.

18. The optical communication system according to claim 10, wherein
the optical signal transmitter further includes a fourth optical communication apparatus, and the fourth optical communication apparatus includes:
another second key manager configured to store and manage a third key and a fourth key obtained from an outside;
another visible light receiver configured to receive fourth visible light and decode the fourth visible light into fourth encrypted data; and
another second encryption and decryption device connected to the another second key manager and the another visible light receiver, the another second encryption and decryption device being configured to decrypt the fourth key stored in the another second key manager according to the third key stored in the another second key manager to obtain a fifth key, and decrypt the fourth encrypted data according to the fifth key obtained by the another second encryption and decryption device to obtain initial communication data.
